(19) United States
(12) Patent Application Publication
(10) Pub. No.: US 2019/0322861 A1
(43) Pub. Date: Oct. 24, 2019

(54) ENGINEERING THERMOPLASTIC COMPOSITIONS WITH HIGH NANO MOLDING BONDING STRENGTH AND LASER DIRECT STRUCTURING FUNCTION

(71) Applicant: SABIC Global Technologies B.V., Bergen op Zoom (NL)

(72) Inventors: Zhenke WEI, Shanghai (CN); Tong WU, Shanghai (CN); Yunan CHENG, Shanghai (CN); Qin WANG, Shanghai (CN)

(21) Appl. No.: 16/095,887

(22) PCT Filed: Apr. 27, 2017
(86) PCT No.: PCT/IB2017/052449

§ 371 Date: Oct. 23, 2018

Related U.S. Application Data
(60) Provisional application No. 62/329,321, filed on Apr. 29, 2016.

(51) Int. Cl. C08L 67/02; C08K 7/14; C08K 3/32; C08K 3/22; C08L 69/00; C08L 77/00

(52) U.S. Cl. CPC C08L 67/02; C08K 7/14; C08K 3/32; C08K 3/22; C08K 2201/003; C08L 77/00; C08K 2003/321; C08K 2003/2282; C08L 69/00

(57) ABSTRACT

A thermoplastic composition includes a polymeric base resin, a glass fiber component, and a laser direct structuring additive. The laser direct structuring additive includes copper chromite black, copper hydroxide phosphate, tin-antimony cassiterite grey or a combination thereof. In some aspects the polymeric base resin includes polybutylene terephthalate (PBT), polyamide (PA), polycarbonate (PC), poly(p-phenylene oxide) (PPO), or combinations thereof. In certain aspects the thermoplastic composition has a nano molding technology (NMT) bonding strength of at least about 20 MPa when bonded to aluminum alloy. In further aspects the thermoplastic composition includes a plating index of at least a about 0.25. The disclosed thermoplastic compositions can be used to form articles such as NMT bonded covers of consumer electronics devices.

### FIELD OF THE DISCLOSURE

The present disclosure relates to laser direct structuring thermoplastic compositions, and in particular to direct structuring thermoplastic compositions having high nano molding technology bonding strength.

### BACKGROUND OF THE DISCLOSURE

Low weight and size are desirable features of modern consumer electronics devices. In order to compete in today's crowded market it is also desirable for the device to have a pleasing appearance, such as a lustrous or luxurious appearance. One way to provide a desirable appearance is with a metal cover. Metal covers, however, must have an inner plastic mold to retain screw bosses and snap-fits. The inner mold is currently glued to the metal cover, requiring an additional “glue” process that gives the cover an unsatisfying thickness.

In addition, modern cellular telephone, or “smart phone” devices have increasing numbers of communication functions (e.g., WiFi, 3G, 4G, Bluetooth), each of which require separate antennas. Size restrictions of modern devices, however, limit the space available for these antennas. The introduction of laser direct structuring (LDS) technology has at least partially addressed these challenges. In LDS technology, a thermoplastic material is doped with a metal-plastic additive, and a laser forms a micro-circuit trace on the thermoplastic material by activating the metal-plastic additive. LDS technology has enabled aggressive space reduction in this area, as well as ultra-fine precision and high reliability. LDS technology has not, however, overcome the challenges presented by the desire for metal covers glued to inner plastic molds described above.

These and other shortcomings are addressed by aspects of the present disclosure.

### SUMMARY

Aspects of the disclosure relate to a thermoplastic composition including a polymeric base resin, a glass fiber component, and a laser direct structuring additive. The laser direct structuring additive includes copper chromite black, copper hydroxide phosphate, tin-antimony cassiterite grey or a combination thereof.

Further aspects of the disclosure relate to methods for making a thermoplastic composition and/or thermoplastic article, including: forming a blend by mixing a polymeric base resin, a glass fiber component, and a laser direct structuring additive; and injection molding, extruding, rotational molding, blow molding or thermoforming the blend to form the thermoplastic composition and/or article. The laser direct structuring additive includes copper chromite black, copper hydroxide phosphate, tin-antimony cassiterite grey or a combination thereof. In certain aspects the thermoplastic article includes a nano molding technology bonded cover of a consumer electronics device.

### DETAILED DESCRIPTION

The present disclosure can be understood more readily by reference to the following detailed description of the disclosure and the Examples included therein. Aspects of the present disclosure incorporate nano molding technology (NMT) technology, in which a polymer resin is injected into a metal surface. The NMT process makes it possible to mechanically bond plastic to metal by etching the metal surface and injection molding the plastic components onto it. The use of NMT technology, with a metal-to-plastic interface having a relatively high bond strength (“NMT bonding strength”), allows portions of consumer electronic products (and other products), such as metal covers, which were traditionally glued to an inner plastic mold, to be replaced with metal/plastic bonded parts. Further, when combined with LDS technology such as that described above, thermoplastic compositions according to aspects of the disclosure can be incorporated into lighter and smaller products as compared to those currently in use.

Thus, in various aspects, the present disclosure pertains to a thermoplastic composition including a polymeric base resin, a glass fiber component, and a laser direct structuring additive. The laser direct structuring additive includes copper chromite black, copper hydroxide phosphate, tin-antimony cassiterite grey or a combination thereof. In certain aspects the thermoplastic composition has an NMT bonding strength of at least 20 megapascals (MPa) when bonded to aluminum alloy. In further aspects the thermoplastic composition exhibits a plating index (PI) of at least 0.25, or at least 0.5, or at least 0.7.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polymeric base resin” includes mixtures of two or more polymeric base resins.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optional additive materials” means that the additive materials can or cannot be included and that the description includes thermoplastic compositions that both include and that do not include additive materials.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein the terms “weight percent,” “wt %,” and “wt. %,” which can be used interchangeably, indicate the percent by weight of a given component based on the total weight of the composition, unless otherwise specified. That is, unless otherwise specified, all wt. % values are based on the total weight of the composition. It should be understood that the sum of wt. % values for all components in a disclosed composition or formulation are equal to 100.

Certain abbreviations are defined as follows: “g” is grams, “kg” is kilograms, “° C.” is degrees Celsius, “min” is minutes, “mm” is millimeter, “MPa” is megapascal, “WiFi” is a system of accessing the internet from remote machines, 3G and 4G refer to mobile communications standards that allow portable electronic devices to access the Internet wirelessly, “GPS” is Global Positioning System—a global system of U.S. navigational satellites which provide positional and velocity data. “LED” is light-emitting diode, “RF” is radio frequency, and “RFID” is radio frequency identification.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Thermoplastic Compositions

In various aspects, the present disclosure pertains to a thermoplastic composition including a polymeric base resin, a glass fiber component, and a laser direct structuring additive. The laser direct structuring additive includes copper chromite black, copper hydroxide phosphate, tin-antimony cassiterite grey or a combination thereof.

### Polymeric Base Resin

In one aspect, the disclosed thermoplastic compositions include a polymeric base resin. In some aspects the polymeric base resin includes polybutylene terephthalate (PBT), polyamide (PA), polycarbonate (PC), poly(p-phenylene oxide) (PPO), or combinations of one or more of these polymers. For example, in particular aspects the polymeric base resin may include PBT and PC, or PA and PPO.

As used herein, polybutylene terephthalate can be used interchangeably with poly(1,4-butylene terephthalate). Polybutylene terephthalate is one type of polyester. Polyesters, which include poly(alkylene dicarboxylates), liquid crystalline polyesters, and polyester copolymers, can be useful in the disclosed thermoplastic compositions of the present disclosure.

Polyesters have repeating units of the following formula (A):

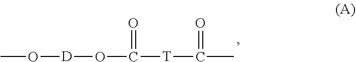

wherein T is a residue derived from a terephthalic acid or chemical equivalent thereof, and D is a residue derived from polymerization of an ethylene glycol, butylene diol, specifically 1,4-butane diol, or chemical equivalent thereof. Chemical equivalents of diacids include dialkyl esters, e.g., dimethyl esters, diaryl esters, anhydrides, salts, acid chlorides, acid bromides, and the like. Chemical equivalents of ethylene diol and butylene diol include esters, such as dialkylesters, diaryl esters, and the like.

In addition to units derived from a terephthalic acid or chemical equivalent thereof, and ethylene glycol or a butylene diol, specifically 1,4-butane diol, or chemical equivalent thereof, other T and/or D units can be present in the polyester, provided that the type or amount of such units do not significantly adversely affect the desired properties of the thermoplastic compositions.

Examples of aromatic dicarboxylic acids include 1,4-naphthalenedicarboxylic acid, 1,5-naphthalenedicarboxylic acid, 2,6-naphthalenedicarboxylic acid, and combinations comprising at least one of the foregoing dicarboxylic acids. Exemplary cycloaliphatic dicarboxylic acids include norbornene dicarboxylic acids, 1,4-cyclohexanedicarboxylic acids, and the like. In a specific aspect, T is derived from a combination of terephthalic acid and isophthalic acid wherein the weight ratio of terephthalic acid to isophthalic acid is 99:1 to 10:90 (or about 99:1 to about 10:90), specifically 55:1 to 50:50 (or about 55:1 to about 1:1).

Examples of C6-C12 aromatic diols include, but are not limited to, resorcinol, hydroquinone, and pyrocatechol, as well as diols such as 1,5-naphthalene diol, 2,6-naphthalene diol, 1,4-naphthalene diol, 4,4′-dihydroxybiphenyl, bis(4-hydroxyphenyl)ether, bis(4-hydroxyphenyl)sulfone, and the like, and combinations comprising at least one of the foregoing aromatic diols.

Exemplary C2-C12 aliphatic diols include, but are not limited to, straight chain, branched, or cycloaliphatic alkane diols such as propylene glycol, i.e., 1,2- and 1,3-propylene glycol, 2,2-dimethyl-1,3-propane diol, 2-ethyl-2-methyl-1,3-propane diol, 1,4-but-2-ene diol, 1,3- and 1,5-pentane diol, dipropylene glycol, 2-methyl-1,5-pentane diol, 1,6-hexane diol, dimethanol decalin, dimethanol bicyclooctane, 1,4-cyclohexane dimethanol, including its cis- and trans-isomers, triethylene glycol, 1,10-decanediol; and combinations comprising at least of the foregoing diols.

In another aspect, the compositions of the present disclosure can include polyesters including, for example, aromatic polyesters, poly(alkylene esters) including poly(alkylene arylates), and poly(cycloalkylene diesters). Aromatic polyesters can have a polyester structure according to formula (A), wherein D and T are each aromatic groups as described hereinabove. In an aspect, useful aromatic polyesters can include, for example, poly(isophthalate-terephthalate-resorcinol)esters, poly(isophthalate-terephthalate-bisphenol A)esters, poly[(isophthalate-terephthalate-resorcinol)ester-co-(isophthalate-terephthalate-bisphenol A)]ester, or a combination comprising at least one of these. Also contemplated are aromatic polyesters with a minor amount, e.g., about 0.5 to about 10 wt. %, based on the total weight of the polyester, of units derived from an aliphatic diacid and/or an aliphatic polyol to make copolyesters. Poly(alkylene arylates) can have a polyester structure according to formula (A), wherein T comprises groups derived from aromatic dicarboxylates, cycloaliphatic dicarboxylic acids, or derivatives thereof.

Examples of specifically useful T groups include, but are not limited to, 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene.

Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations including at least one of the foregoing polyesters can also be used.

Copolymers including alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer includes greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s can also include poly(alkylene cyclohexanedicarboxylate)s. Of these, a specific example is poly(1,4-cyclohexane-dimethanol-1,4-cyclohexanedicarboxylate) (PCCD), having recurring units of formula (B):

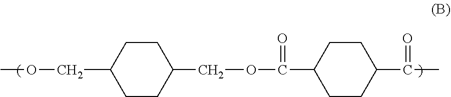

wherein, as described using formula (A), R² is a 1,4-cyclohexanedimethylene group derived from 1,4-cyclohexanedimethanol, and T is a cyclohexane ring derived from cyclohexanedicarboxylate or a chemical equivalent thereof, and can comprise the cis-isomer, the trans-isomer, or a combination comprising at least one of the foregoing isomers.

Polyesters, including polybutylene terephthalate, can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). The condensation reaction may be facilitated by the use of a catalyst, with the choice of catalyst being determined by the nature of the reactants. The various catalysts for use herein are very well known in the art and are too numerous to mention individually herein. Generally, however, when an alkyl ester of the dicarboxylic acid compound is employed, an ester interchange type of catalyst is preferred, such as Ti(OC₄H₉)₆ in n-butanol.

It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

In another aspect, the composition can further comprise poly(1,4-butylene terephthalate) or “PBT” resin. PBT can be obtained by polymerizing a glycol component of which at least 70 mol %, preferably at least 80 mol %, consists of tetramethylene glycol and an acid or ester component of which at least 70 mol %, preferably at least 80 mol %, consists of terephthalic acid and/or polyester-forming derivatives therefore. Commercial examples of PBT include those available under the trade names VALOX™ 315, VALOX™ 195 and VALOX™ 176, manufactured by SABIC™, having an intrinsic viscosity of 0.1 deciliters per gram (dl/g) to about 2.0 dl/g (or 0.1 dl/g to 2 dl/g) as measured in a 60:40 phenol/tetrachloroethane mixture or similar solvent at 23 degrees Celsius (° C.) to 30° C. In one aspect, the PBT resin has an intrinsic viscosity of 0.1 dl/g to 1.4 dl/g (or about 0.1 dl/g to about 1.4 dl/g), specifically 0.4 dl/g to 1.4 dl/g (or about 0.4 dl/g to about 1.4 dl/g).

As used herein, poly(p-phenylene oxide) can be used interchangeably with poly(p-phenylene ether) or poly (2,6 dimethyl-p-phenylene oxide). Poly(p-phenylene oxide) may be included by itself or may be blended with other polymers, including but not limited to polystyrene, high impact styrene-butadiene copolymer and/or polyamide.

As used herein, polycarbonate refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates. Polycarbonates, and combinations comprising thereof, may also be used as the polymer base resin. As used herein, “polycarbonate” refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates. The terms “residues” and “structural units”, used in reference to the constituents of the polymers, are synonymous throughout the specification. In certain aspects the polycarbonate polymer is a Bisphenol-A polycarbonate, a high molecular weight (Mw) high flow/ductile (HFD) polycarbonate, a low Mw HFD polycarbonate, or a combination thereof.

The terms “BisA,” “BPA,” or “bisphenol A,” which can be used interchangeably, as used herein refers to a compound having a structure represented by formula (C):

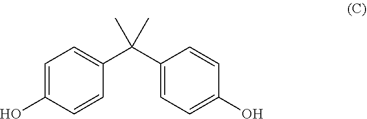 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

In addition to the polycarbonates described above, combinations of the polycarbonate with other thermoplastic polymers, for example combinations of homopolycarbonates, copolycarbonates, and polycarbonate copolymers with polyesters, can be used. For example, useful polyesters include, but are not limited to, poly(alkylene dicarboxylates), liquid crystalline polyesters, and polyester copolymers as described herein. The polyesters described herein can generally be completely miscible with the polycarbonates when blended.

In a specific example, the polycarbonate is a copolymer. The copolymer may comprise repeating units derived from BPA. In yet a further example, the copolymer comprises repeating units derived from sebacic acid. More specifically, the copolymer may comprise repeating units derived from sebacic acid and BPA. Useful polycarbonate copolymers are commercially available and include, but are not limited to, those marketed under the trade names LEXAN™ EXL and LEXAN™ HFD polymers available from SABIC™.

In further aspects, the polymeric base resin may comprise a polycarbonate-polysiloxane copolymer. Non-limiting examples of polycarbonate-polysiloxane copolymers may comprise various copolymers available from SABIC™ Innovative plastics. In an aspect, the polysiloxane-polycarbonate copolymer can contain 6% by weight polysiloxane content based upon the total weight of the polysiloxane-polycarbonate copolymer. In various aspects, the 6% by weight polysiloxane block copolymer can have a weight average molecular weight (Mw) of from about 23,000 to 24,000 Daltons using gel permeation chromatography with a bisphenol A polycarbonate absolute molecular weight standard. In certain aspects, the 6% weight siloxane polysiloxane-polycarbonate copolymer can have a melt volume flow rate (MVR) of about 10 cm³/10 min at 300° C./1.2 kg (see for example, C9030T, a 6% by weight polysiloxane content copolymer available from SABIC Innovative Plastics as “transparent” EXL C9030T resin polymer). In another example, the polysiloxane-polycarbonate block can comprise 20% by weight polysiloxane based upon the total weight of the polysiloxane block copolymer. For example, an appropriate polysiloxane-polycarbonate copolymer can be a bisphenol A polysiloxane-polycarbonate copolymer endcapped with para-cumyl phenol (PCP) and having a 20% polysiloxane content (see C9030P, commercially available from SABIC Innovative Plastics as the “opaque” EXL C9030P). In various aspects, the weight average molecular weight of the 20% polysiloxane block copolymer can be about 29,900 Daltons to about 31,000 Daltons when tested according to a polycarbonate standard using gel permeation chromatography (GPC) on a cross-linked styrene-divinylbenzene column and calibrated to polycarbonate references using a UV-VIS detector set at 264 nm on 1 mg/ml samples eluted at a flow rate of about 1.0 ml/minute. Moreover, the 20% polysiloxane block copolymer can have an MVR at 300° C./1.2 kg of 7 cm³ 10 min and can exhibit siloxane domains sized in a range of from about 5 micron to about 20 micrometers (microns, μm).

As used herein, a polyamide is a polymer having repeating units linked by amide bonds, and can include aliphatic polyamides (PA) (e.g., the various forms of nylon such as nylon 6 (PA6), nylon 66 (PA66) and nylon 9 (PA9)), polyphthalamides (e.g., PPA/high performance polyamide) and aramides (e.g., para-aramid and meta-aramid).

In a further aspect, the polymeric base resin can have a weight average molecular weight from 30,000 Daltons to 150,000 Daltons, or from about 30,000 Daltons to about 150,000 Daltons.

A mixture of polymeric base resins with differing viscosities can be used to make a blend of two or more polymeric base resins to allow for control of viscosity of the final thermoplastic composition.

In some aspects, the polymeric base resin can be present in the thermoplastic composition in an amount from 20 weight percent (wt. %) to 90 wt. %, or from about 20 wt. % to about 90 wt. %. In other aspects, the polymeric base resin can be present in an amount from 30 wt. % to 80 wt. % or from about 30 wt. % to about 80 wt. %, or from 40 wt. % to 70 wt. % or from about 40 wt. % to about 70 wt. %, or from 50 wt. % to 70 wt. % or from about 50 wt. % to about 70 wt. %, or from 55 wt. % to 65 wt. % or from about 55 wt. % to about 65 wt. %.

### Glass Fiber Component

In one aspect, the disclosed thermoplastic compositions include a glass fiber component. In a further aspect, the glass fiber included in the glass fiber component is selected from E-glass, S-glass, AR-glass, T-glass, D-glass and R-glass. In a still further aspect, the glass fiber is selected from E-glass, S-glass, and combinations thereof. In a still further aspect, the glass fiber is one or more S-glass materials. High-strength glass is generally known as S-type glass in the United States, R-glass in Europe and T-glass in Japan. S-glass was originally developed for military applications in the 1960s, and a lower cost version, S-2 glass, was later developed for commercial applications. High-strength glass has appreciably higher amounts of silica oxide, aluminum oxide and magnesium oxide than E-glass. S-2 glass is approximately 40-70% stronger than E-glass. The glass fibers can be made by standard processes, e.g., by steam or air blowing, flame blowing, and mechanical pulling. Exemplary glass fibers for thermoplastic compositions of the present disclosure may be made by mechanical pulling.

The glass fibers may be sized or unsized. Sized glass fibers are coated on their surfaces with a sizing composition selected for compatibility with the polymeric base resin. The sizing composition facilitates wet-out and wet-through of the polymeric base resin upon the fiber strands and assists in attaining desired physical properties in the thermoplastic composition.

In various further aspects, the glass fiber is sized with a coating agent. In a further aspect, the coating agent is present in an amount from 0.1 wt. % to 5 wt. %, or from about 0.1 wt. % to about 5 wt. % based on the weight of the glass fibers. In a still further aspect, the coating agent is present in an amount from about 0.1 wt. % to about 2 wt. % based on the weight of the glass fibers.

In preparing the glass fibers, a number of filaments can be formed simultaneously, sized with the coating agent and then bundled into what is called a strand. Alternatively the strand itself may be first formed of filaments and then sized. The amount of sizing employed is generally that amount which is sufficient to bind the glass filaments into a continuous strand and ranges from 0.1 wt. % to 5 wt. %, or from about 0.1 to about 5 wt. %, from 0.1 wt. % to 2 wt. % or from about 0.1 to 2 wt. % based on the weight of the glass fibers. Generally, this may be 1.0 wt. % or about 1.0 wt. % based on the weight of the glass filament.

In a further aspect, the glass fiber can be continuous or chopped. In a still further aspect, the glass fiber is continuous. In yet a further aspect, the glass fiber is chopped. Glass fibers in the form of chopped strands may have a length of 0.3 millimeter (mm) to 10 centimeters (cm) or about 0.3 mm to about 10 cm, specifically 0.5 millimeter (mm) to 5 cm or about 0.5 mm to about 5 cm, and more specifically 1 mm to 2.5 cm, or about 1.0 millimeter to about 2.5 centimeters. In various further aspects, the glass fiber has a length from 0.2 mm to 20 mm or about 0.2 mm to about 20 mm. In a yet further aspect, the glass fiber has a length from 0.2 mm to 10 mm, or from about 0.2 mm to about 10 mm. In an even further aspect, the glass fiber has a length from 0.7 mm to 7 mm, or from about 0.7 mm to about 7 mm. In this area, where a thermoplastic resin is reinforced with glass fibers in a composite form, fibers having a length of 0.4 mm or about 0.4 mm are generally referred to as long fibers, and shorter ones are referred to as short fibers. In a still further aspect, the glass fiber can have a length of 1 mm or longer. In yet a further aspect, the glass fiber can have a length of 2 mm or longer.

In various further aspects, the glass fiber has a round (or circular), flat, or irregular cross-section. Thus, use of non-round fiber cross sections is possible. In a still further aspect, the glass fiber has a circular cross-section. In yet further aspect, the diameter of the glass fiber is from 1 micrometer (micron, μm) to 15 μm, or from about 1 μm to about 15 μm. In an even further aspect, the diameter of the glass fiber is from 4 μm to 10 μm or from about 4 μm to about 10 μm. In a still further aspect, the diameter of the glass fiber is from 1 μm to 10 μm or from about 1 to about 10 μm. In a still further aspect, the glass fiber has a diameter from 7 μm to 10 μm or from about 7 μm to about 10 μm.

As provided above, glass fiber having a flat cross-section may be used. A flat glass fiber may have an aspect ratio for the flat cross-section of 2 to 5 or from about 2 to about 5. For example, the flat cross-section glass may have a flat ratio of 4:1.

In some aspects, the glass fiber component is present in an amount from greater than 0 wt. % to 60 wt. % or from greater than 0 wt. % to about 60 wt. %. In further aspects, the glass fiber component is present in an amount from 10 wt. % to 60 wt. % or from about 10 wt. % to about 60 wt. %, or from 20 wt. % to 60 wt. % or from about 20 wt. % to about 60 wt. %, or from 20 wt. % to 50 wt. %, or from about 20 wt. % to about 50 wt. %, or from 20 wt. % to 40 wt. % or from about 20 wt. % to about 40 wt. %.

One purely exemplary glass fiber suitable for use in the glass fiber component in an aspect of the disclosure is an E-glass fiber ECS303H, available from Chongqing Polycomp International Corp.

### Laser Direct Structuring Additive

Aspects of the thermoplastic composition include a laser direct structuring (LDS) additive. In certain aspects, the LDS additive includes copper chromite black, copper hydroxide phosphate, tin-antimony cassiterite grey or a combination thereof. Cassiterite may refer to a tin oxide material. An exemplary copper chromite black LDS additive is Black 1G, available from The Shepherd Color Company. An exemplary copper hydroxide phosphate is Iriotec™ 8840, available from Merck. An exemplary tin-antimony cassiterite grey is S-5000, available from Ferro.

In some aspects, the LDS additive may be present in the thermoplastic composition in an amount of from 0.5 wt. % to 20 wt. %, or from about 0.5 wt. % to about 20 wt. %. In further aspects, the LDS additive may be present in the thermoplastic composition in an amount of from 0.5 wt. % to 15 wt. %, or from about 0.5 wt. % to about 15 wt. %, or 1 wt. % to 10 wt. % or from about 1 wt. % to about 10 wt. %, or from 2 wt. % to 12 wt. % or from about 2 wt. % to about 12 wt. %, or from 2 wt. % to 8 wt. % or from about 2 wt. % to about 8 wt. %, or from 3 wt. % to 6 wt. % or from about 3 wt. % to about 6 wt. %.

It is believed that the LDS additive contributes to the thermoplastic composition having an improved plating index as compared to a thermoplastic composition without an LDS additive.

Plating index may be determined by a two-step process of laser etching and copper chemical deposition for 45 minutes according to the “LPKF Method” or “LPKF-LDS Method” established by LPKF Laser & Electronics. In the first step, molded plaques of the materials to be evaluated (e.g. the thermoplastic composition) are laser etched/structured with the LPKF pattern, in which the laser variables are power, frequency and speed. Following this step, the laser structured plaque and one reference stick (material: Pocan™ DP 7102 from Lanxess) are placed in the copper bath until the reference stick has a copper thickness of nearly 5 μm. The plaque and reference stick are then removed, rinsed and dried, and the copper thicknesses for the reference stick are measured twice on each side by an XRF method (in accordance with ASTM B568 (2014)) and averaged over all four points. This is noted as X_{ref}. Then, two points are measured for each parameter field and averaged for each field. Plating index can then be calculated as:

$$Plating index = \frac{Average copper thickness for one parameter field}{Average copper thickness for reference stick {X}_{ref}}$$

Thus, in some aspects, the thermoplastic composition has a plating index of at least 0.15. In other aspects, the thermoplastic composition has a plating index of at least 0.20, or at least 0.25, or at least 0.30, or at least 0.35, or at least 0.40, or at least 0.45, or at least 0.50, or at least 0.55, or at least 0.60, or at least 0.65, or at least 0.70.

### Optional Polymer Composition Additives

In addition to the foregoing components, the disclosed thermoplastic compositions can optionally include a balance amount of one or more additive materials ordinarily incorporated in thermoplastic compositions of this type, with the proviso that the additives are selected so as to not significantly adversely affect the desired properties of the composition. Combinations of additives can be used. Such additives can be mixed at a suitable time during the mixing of the components for forming the composition. Exemplary and non-limiting examples of additive materials that can be present in the disclosed thermoplastic compositions include one or more of a reinforcing filler, enhancer, acid scavenger, anti-drip agent, antioxidant, antistatic agent, chain extender, colorant (e.g., pigment and/or dye), de-molding agent, flow promoter, flow modifier, lubricant, mold release agent, plasticizer, quenching agent, flame retardant (including for example a thermal stabilizer, a hydrolytic stabilizer, or a light stabilizer), impact modifier, ultraviolet (UV) absorbing additive, UV reflecting additive and UV stabilizer.

In an aspect, suitable impact modifiers can include an epoxy-functional block copolymer. The epoxy-functional block copolymer can include units derived from a C₂₋₂₀ olefin and units derived from a glycidyl (meth)acrylate. Exemplary olefins include ethylene, propylene, butylene, and the like. The olefin units can be present in the copolymer in the form of blocks, e.g., as polyethylene, polypropylene, polybutylene, and the like blocks. It is also possible to use mixtures of olefins, i.e., blocks containing a mixture of ethylene and propylene units, or blocks of polyethylene together with blocks of polypropylene.

In addition to glycidyl (meth)acrylate units, the epoxy-functional block copolymers can further include additional units, for example C₁₋₄ alkyl (meth)acrylate units. In one aspect, the impact modifier is terpolymeric, comprising polyethylene blocks, methyl acrylate blocks, and glycidyl methacrylate blocks. Specific impact modifiers are a co or terpolymer including units of ethylene, glycidyl methacrylate (GMA), and methyl acrylate. Suitable impact modifiers include the ethylene-methyl acrylate-glycidyl methacrylate terpolymer comprising 8 wt. % or about 8 wt. % glycidyl methacrylate units available under the trade name LOTADER™ AX8900 from Arkema. Another epoxy-functional block copolymer that can be used in the composition includes ethylene acrylate, for example an ethylene-ethylacrylate copolymer having an ethylacrylate content of less than 20%, available from Rohm and Haas (Dow Chemical) under the trade name Paraloid™ EXL-3330. It will be recognized that combinations of impact modifiers may be used. In some aspects, the impact modifier may be present in an amount from greater than 0 wt. % to 10 wt. % or from greater than 0 wt. % to about 10 wt. %. In further aspects, the impact modifier is present in an amount from 0.01 wt. % to 8 wt. % or from about 0.01 wt. % to about 8 wt. %, or from 0.01 wt. % to 7 wt. % or from about 0.01 wt. % to about 7 wt. %, or from 0.01 wt. % to 6 wt. % or from about 0.01 wt. % to about 6 wt. %, or from 2 wt. % to 8 wt. % or from about 2 wt. % to about 8 wt. %, or from 3 wt. % to 7 wt. % or from about 3 wt. % to about 7 wt. %.

In a further aspect, the disclosed thermoplastic compositions can further include an antioxidant or “stabilizer.” Numerous stabilizers are known may be used, in one aspect the stabilizer is a hindered phenol, such as Irganox™ 1010, available from BASF. In some aspects, the stabilizer may be present in an amount from greater than 0 wt. % to 5 wt. % or from greater than 0 wt. % to about 5 wt. %. In further aspects, the stabilizer is present in an amount from 0.01 wt. % to 3 wt. % or from about 0.01 wt. % to about 3 wt. %, or from 0.01 wt. % to 2 wt. % or from about 0.01 wt. % to about 2 wt. %, or from 0.01 wt. % to 1 wt. or from about 0.01 wt. % to about 1 wt. %, or from 0.01 wt. % to 0.05 wt. % or from about 0.01 wt. % to about 0.05 wt. %, or from 0.01 wt. % to 0.02 wt. % or from about 0.01 wt. % to about 0.02 wt. %.

In certain aspects the composition may include an enhancer, which may improve the NMT bonding strength and/or the melt strength of the composition. Suitable enhancers may include polymeric or non-polymeric materials. Exemplary, but by no means limiting enhancers include polyethylene terephthalate, polyester-polyether copolymer (e.g., one or more of DuPont's Hytrel™ polyester elastomers), high molecular weight polyacrylates (e.g., poly(methyl methacrylate) (PMMA), poly(methacrylate) (PMA), and poly(hydroxyethyl methacrylate)), fluoropolymers, and combinations thereof. In certain aspects, the enhancer is present in an amount of from greater than 0 wt. % to 10 wt. % or from greater than 0 wt. % to about 10 wt. %. In other aspects, the enhancer is present in an amount of from greater than 0 wt. % to 8 wt. %, or from greater than 0 wt. % to about 8 wt. %, or from greater than 0 wt. % to 5 wt. %, or from greater than 0 wt. % to about 5 wt. %, or from greater than 0 wt. % to 3 wt. %, or from greater than 0 wt. % to about 3 wt. %, or from 1 wt. % to 4 wt. %, or from about 1 wt. % to about 4 wt. %, or from 2 wt. % to 3 wt. %, or from about 2 wt. % to about 3 wt. %.

In some aspects the composition may have a relatively high NMT bonding strength when bonded onto a metal surface. One purely exemplary metal surface is aluminum alloy. For example, in certain aspects the composition, when bonded to aluminum alloy, has an NMT bonding strength of greater than about 20 MPa. In further aspects the composition has an NMT bonding strength, when bonded to aluminum alloy, of greater than 25 MPa, or greater than 26 MPa, or greater than 27 MPa, or greater than 28 MPa, or greater than 29 MPa, or greater than 30 MPa. In a particular aspect the aluminum alloy is A5052 aluminum alloy. It will be recognized, however, that other commercially available aluminum alloys could be used for the metal surface and may provide comparable NMT bonding strengths. Bonding strength may be determined using a universal testing machine (UTM), such as the MTS Criterion™ Series 40 Electromechanical Universal Test Systems (e.g., Model 44, C44.304).

### Methods of Manufacture

The thermoplastic compositions of the present disclosure can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between 230° C. and 350° C. (or about 230° C. and about 350° C.) in the molten resin composition, although higher temperatures can be used provided that the residence time of the resin in the processing equipment is kept short. In some aspects the melt processed composition exits processing equipment such as an extruder through small exit holes in a die. The resulting strands of molten resin are cooled by passing the strands through a water bath. The cooled strands can be chopped into small pellets for packaging and further handling.

Compositions can be manufactured by various methods. For example, the polymeric base resin, the glass fiber component, the laser direct structuring additive, and/or other optional components are first blended in a HENSCHEL-Mixer™ high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

### Articles of Manufacture

In one aspect, the present disclosure pertains to shaped, formed, or molded articles comprising the thermoplastic compositions. The thermoplastic compositions can be molded into useful shaped articles by a variety of means such as injection molding, extrusion, rotational molding, blow molding and thermoforming to form articles and structural components of, for example, personal or commercial consumer electronics, including but not limited to cellular telephones, tablet computers, personal computers, notebook and portable computers, and other such equipment, medical applications, RFID applications, automotive applications, and the like, in particular NMT applications. In a further aspect, the article is extrusion molded. In a still further aspect, the article is injection molded.

In a further aspect, the resulting disclosed compositions can be used to provide any desired shaped, formed, or molded articles. For example, the disclosed compositions can be molded into useful shaped articles by a variety of means such as injection molding, extrusion, rotational molding, blow molding and thermoforming. As noted above, the disclosed compositions are particularly well suited for use in the manufacture of electronic components and devices. As such, according to some aspects, the disclosed thermoplastic compositions can be used to form articles such as NMT bonded covers of consumer electronics devices.

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1: A thermoplastic composition comprising: a polymeric base resin; a glass fiber component; and a laser direct structuring additive, the laser direct structuring additive comprising copper chromite black, copper hydroxide phosphate, tin-antimony cassiterite grey or a combination thereof.

Aspect 2: A thermoplastic composition consisting essentially of: a polymeric base resin; a glass fiber component; and a laser direct structuring additive, the laser direct structuring additive comprising copper chromite black, copper hydroxide phosphate, tin-antimony cassiterite grey or a combination thereof.

Aspect 3: A thermoplastic composition consisting of: a polymeric base resin; a glass fiber component; and a laser direct structuring additive, the laser direct structuring additive comprising copper chromite black, copper hydroxide phosphate, tin-antimony cassiterite grey or a combination thereof.

Aspect 4: The thermoplastic composition according to any of Aspects 1-3, wherein the polymeric base resin comprises polybutylene terephthalate (PBT), polyamide (PA), polycarbonate (PC), poly(p-phenylene oxide) (PPO), or combinations thereof.

Aspect 5: The thermoplastic composition according to any of Aspects 1-4, wherein the polymeric base resin is present in an amount of from about 20 wt. % to about 90 wt. %.

Aspect 6: The thermoplastic composition according to any of Aspects 1-4, wherein the polymeric base resin is present in an amount of from 20 wt. % to 90 wt. %.

Aspect 7: The thermoplastic composition according to any of Aspects 1-6, wherein the polymeric base resin is present in an amount of from about 50 wt. % to about 70 wt. %.

Aspect 8: The thermoplastic composition according to any of Aspects 1-6, wherein the polymeric base resin is present in an amount of 50 wt. % or about 70 wt. %.

Aspect 9: The thermoplastic composition according to any of Aspects 1-6, wherein the polymeric base resin is present in an amount of from 50 wt. % to 60 wt. %.

Aspect 10: The thermoplastic composition according to any of Aspects 1-9, wherein the glass fiber component is present in an amount of from about 10 wt. % to about 60 wt. %.

Aspect 11: The thermoplastic composition according to any of Aspects 1-9, wherein the glass fiber component is present in an amount of from 10 wt. % to 60 wt. %.

Aspect 12: The thermoplastic composition according to any of Aspects 1-9, wherein the glass fiber component is present in an amount of from about 20 wt. % to about 40 wt. %.

Aspect 13: The thermoplastic composition according to any of Aspects 1-9, wherein the glass fiber component is present in an amount of from 20 wt. % to 40 wt. %.

Aspect 14: The thermoplastic composition according to any of Aspects 1-9, wherein the glass fiber component is present in an amount of 30 wt. % or about 30 wt. %.

Aspect 15: The thermoplastic composition according to any of Aspects 1-14, wherein the laser direct structuring additive is present in an amount of from about 0.5 wt. % to about 20 wt. %.

Aspect 16: The thermoplastic composition according to any of Aspects 1-14, wherein the laser direct structuring additive is present in an amount of from 0.5 wt. % to 20 wt. %.

Aspect 17: The thermoplastic composition according to any of Aspects 1-14, wherein the laser direct structuring additive is present in an amount of from about 2 wt. % to about 12 wt. %.

Aspect 18: The thermoplastic composition according to any of Aspects 1-14, wherein the laser direct structuring additive is present in an amount of from 2 wt. % to 12 wt. %.

Aspect 19: The thermoplastic composition according to any of Aspects 1-14, wherein the laser direct structuring additive is present in an amount of from about 2 wt. % to about 8 wt. %.

Aspect 20: The thermoplastic composition according to any of Aspects 1-14, wherein the laser direct structuring additive is present in an amount of from 2 wt. % to 8 wt. %.

Aspect 21: The thermoplastic composition according to any of Aspects 1-14, wherein the laser direct structuring additive is present in an amount of 5 wt. % or about 5 wt. %.

Aspect 22: The thermoplastic composition according to any of Aspects 1-21, further comprising an enhancer in an amount of up to 10 wt. %.

Aspect 23: The thermoplastic composition according to any of Aspects 1-21, further comprising an enhancer in an amount of up to 8 wt. %.

Aspect 24: The thermoplastic composition according to any of Aspects 1-21, further comprising an enhancer in an amount of up to 5 wt. %.

Aspect 25: The thermoplastic composition according to any of Aspects 1-24, further comprising an impact modifier in an amount of up to 10 wt. %.

Aspect 26: The thermoplastic composition according to any of Aspects 1-25, wherein the thermoplastic composition comprises a nano molding technology bonding strength of at least 20 MPa when bonded to aluminum alloy.

Aspect 27: The thermoplastic composition according to any of Aspects 1-26, wherein the thermoplastic composition comprises a plating index of at least 0.25.

Aspect 28: The thermoplastic composition according to any of Aspects 1-26, wherein the thermoplastic composition comprises a plating index of at least 0.5.

Aspect 29: The thermoplastic composition according to any of Aspects 1-26, wherein the thermoplastic composition comprises a plating index of at least 0.6.

Aspect 30: The thermoplastic composition according to any of Aspects 1-26, wherein the thermoplastic composition comprises a plating index of at least 0.7.

Aspect 31: The thermoplastic composition according to any of Aspects 1-30, wherein the glass fiber component comprises round GF having a diameter of from about 7 μm to about 15 μm, or a flat glass fiber, or a combination thereof.

Aspect 32: The thermoplastic composition according to any of Aspects 1-30, wherein the glass fiber component comprises round GF.

Aspect 33: The thermoplastic composition according to any of Aspects 1-30, wherein the glass fiber component comprises round GF having a diameter of from about 7 μm to about 15 μm.

Aspect 34: The thermoplastic composition according to any of Aspects 1-33, wherein the laser direct structuring additive comprising copper chromite black, copper hydroxide phosphate, tin-antimony cassiterite grey or a combination thereof.

Aspect 35: The thermoplastic composition according to any of Aspects 1-34, the laser direct structuring additive has an average particle size of about 1 μm.

Aspect 36: The thermoplastic composition according to any of Aspects 1-34, the laser direct structuring additive has an average particle size of about 600 nm.

Aspect 37: A method for making a thermoplastic article, comprising: forming a blend by mixing: a polymeric base resin; a glass fiber component; and a laser direct structuring additive, the laser direct structuring additive comprising copper chromite black, copper hydroxide phosphate, tin-antimony cassiterite grey or a combination thereof, and injection molding, extruding, rotational molding, blow molding or thermoforming the blend to form the thermoplastic.

Aspect 38: The method according to Aspect 37, wherein the polymeric base resin comprises polybutylene terephthalate, polyamide, polycarbonate, poly(p-phenylene oxide), or combinations thereof.

Aspect 39: The method according to Aspect 37 or 38, wherein the thermoplastic article comprises a nano molding technology bonded cover of a consumer electronics device.

Aspect 40: The method according to any of Aspects 37-39, wherein the polymeric base resin is present in an amount of from about 20 wt. % to about 90 wt. %, the glass fiber component is present in an amount of from about 10 wt. % to about 60 wt. %, and the laser direct structuring additive is present in an amount of from about 0.5 wt. % to about 20 wt. %.

Aspect 41: The method according to any of Aspects 37-40, wherein the blend further comprises an enhancer in an amount of up to about 5 wt. %.

Aspect 42: The method according to any of Aspects 37-41, wherein the blend further comprises an impact modifier in an amount of up to about 10 wt. %.

Aspect 43: The method according to any of Aspects 37-42, wherein the thermoplastic article comprises a nano molding technology bonding strength of at least about 20 MPa when bonded to aluminum alloy.

Aspect 44: The method according to any of Aspects 37-43, wherein the thermoplastic article comprises a plating index of at least about 0.25.

Aspect 45: A thermoplastic article comprising: a polymeric base resin; a glass fiber component; and a laser direct structuring additive, the laser direct structuring additive comprising copper chromite black, copper hydroxide phosphate, tin-antimony cassiterite grey or a combination thereof.

Aspect 46: The thermoplastic article according to Aspect 45, wherein the thermoplastic article comprises a nano molding technology bonded cover of a consumer electronics device.

Aspect 47: The thermoplastic article according to Aspect 45 or 46, wherein the polymeric base resin comprises polybutylene terephthalate (PBT), polyamide (PA), polycarbonate (PC), poly(p-phenylene oxide) (PPO), or combinations thereof.

Aspect 48: The thermoplastic article according to any of Aspects 45-47, wherein the polymeric base resin is present in an amount of from about 20 wt. % to about 90 wt. %.

Aspect 49: The thermoplastic article according to any of Aspects 45-47, wherein the polymeric base resin is present in an amount of from about 50 wt. % to about 70 wt. %.

Aspect 50: The thermoplastic article according to any of Aspects 45-49, wherein the glass fiber component is present in an amount of from about 10 wt. % to about 60 wt. %.

Aspect 51: The thermoplastic article according to any of Aspects 45-59, wherein the glass fiber component is present in an amount of from about 20 wt. % to about 40 wt. %.

Aspect 52: The thermoplastic article according to any of Aspects 45-51, wherein the laser direct structuring additive is present in an amount of from about 0.5 wt. % to about 20 wt. %.

Aspect 53: The thermoplastic article according to any of Aspects 45-51, wherein the laser direct structuring additive is present in an amount of from about 2 wt. % to about 8 wt. %.

Aspect 54: The thermoplastic article according to any of Aspects 45-53, further comprising an enhancer in an amount of up to about 5 wt. %.

Aspect 55: The thermoplastic article according to any of Aspects 45-54, further comprising an impact modifier in an amount of up to about 10 wt. %.

Aspect 56: The thermoplastic article according to any of Aspects 45-55, wherein the thermoplastic article comprises a nano molding technology bonding strength of at least about 20 MPa when bonded to aluminum alloy.

Aspect 57: The thermoplastic article according to any of Aspects 45-56, wherein the thermoplastic article comprises a plating index of at least about 0.25.

Aspect 58: A method for making a thermoplastic composition, comprising:
forming a blend by mixing: a polymeric base resin; a glass fiber component; and a laser direct structuring additive, the laser direct structuring additive comprising copper chromite black, copper hydroxide phosphate, tin-antimony cassiterite grey or a combination thereof; and
injection molding, extruding, rotational molding, blow molding or thermoforming the blend to form the thermoplastic composition.

Aspect 59: The method according to Aspect 58, wherein the polymeric base resin comprises polybutylene terephthalate, polyamide, polycarbonate, poly(p-phenylene oxide), or combinations thereof.

Aspect 60: The method according to Aspect 58 or 59, wherein the polymeric base resin is present in an amount of from about 20 wt. % to about 90 wt. %, the glass fiber component is present in an amount of from about 10 wt. % to about 60 wt. %, and the laser direct structuring additive is present in an amount of from about 0.5 wt. % to about 20 wt. %.

Aspect 61: The method according to any of Aspects 58-60, wherein the blend further comprises an enhancer in an amount of up to 5 wt. %.

Aspect 62: The method according to any of Aspects 58-61, wherein the blend further comprises an impact modifier in an amount of up to 10 wt. %.

Aspect 63: The method according to any of Aspects 58-62, wherein the thermoplastic composition comprises a nano molding technology bonding strength of at least about 20 MPa when bonded to aluminum alloy.

Aspect 64: The method according to any of Aspects 58-63, wherein the thermoplastic composition comprises a plating index of at least 0.25.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt. %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The materials listed in Table 1 were employed in the examples:

TABLE 1
Materials.

| Function | Item | Chemical Description | Source, Vendor |
|---|---|---|---|
| Main | PBT | Polybutylene terephthalate, MW | SABIC ™ Innovative |
| resin | | range from 150,000 to 30,000 | Plastics |
| | | Daltons (PBT 195) | |
| Main | HFD PC | Sebacic Acid/BPA copolymer, | SABIC Innovative Plastics |
| resin | | high flow | |
| Main | HFD PC | Sebacic acid/BPA/PCP | SABIC Innovative Plastics |
| resin | | copolymer, low flow | |
| Main | EXL PC | 20% PC/siloxane copolymer, | SABIC Innovative Plastics |
| resin | | PCP endcapped (9030P) | |
| Main | EXL PC | Transparent 6% PC/Siloxane | SABIC Innovative Plastics |
| resin | (transparent) | copolymer (9030T) | |
| Glass | GF1 | 10 μm E-glass GF | ECS303H, Chongqing |
| fiber (GF) | | (functionalized to enhance PBT | Polycomp International |
| | | compatibility) | Corp. |
| Glass | GF2 | E-glass fiber, ‘flat’ cross section | CSG 3PA-830, Nittobo |
| fiber (GF) | | with aspect ratio of about 2 to 5 | |
| Enhancer | EH1 | Hytrel ™ 4056 | DuPont |
| Impact | IM1 | Ethylene-ethylacrylate | Paraloid ™ EXL3330, |
| modifiers | | copolymer with ethylacrylate | Rohm and Haas, China |
| | | below 20% | Holding Co., LTD. |
| | IM2 | Terpolymer: ethylene-methyl | Lotader ™ AX 8900, |
| | | acrylate-glycidyl methacrylate | Arkema Inc. |
| | IM4 | Siloxane copolyester modifier | Tegomer ™ H-Si 6440P, |
| | | | Evonik |
| Stabilizers | STAB1 | Hindered phenol stabilizer | Irganox ™ 1010 |
| | STAB2 | Tris(2,4-ditert-butylphenyl) | Irgafos ™ 168, BASF |
| | | Phosphite | |
| | STAB3 | Phosphorous acid ester | Hostanox ™ P-EPQ ™ P, |
| | | | Clariant |
| | STAB4 | Z21-82/MZP, Mono zinc | Z 21-82, Budenheim |
| | | phosphate | |
| | STAB5 | Modified styrene-acrylate-epoxy | Joncryl ™ ADR-4368 CS, |
| | | oligomer | BASF |
| Mold | MR | Pentaerythritol tetrastearate | Glycolube ™ P(ETS), |
| release | | | Longsha Co., LTD. |
| agent | | | |
| LDS | LDS1 | Copper chromite black, (mean | Black 1G, The Shepherd |
| additives | | particle size, 1.5 μm) | Color Co. |
| | LDS2 | Copper chromite black, (mean | Black 30C965, The |
| | | particle size 0.7 μm) | Shepherd Color Co. |
| | LDS2 | Copper hydroxide phosphate | Iriotec ™ 8840, Merck |
| | LDS3 | Tin-antimony cassiterite grey | S-5000, Ferro |

Nano injection molding process and bonding strength testing were conducted at SABIC Technology Center (Japan) (JTC).

Injection molding trial was completed at JTC under the molding conditions as shown in Table 2. Injection speed as millimeters per second (mm/s), cooling time as seconds (s).

TABLE 2
Injection molding conditions.

| | | | Injection | Cooling | |
|---|---|---|---|---|---|
| | | Tool Temp | Speed | time | Max P |
| Dry (° C.) | Processing Temp (° C.) | Cav/Core (° C.) | (mm/s) | (sec) | (bar) |
| ~120-140 | 280-280-280-280-280 | 140/140 | 10 | 20-50 | 100 |

The thermoplastic compositions were bonded to aluminum alloy (type A5052, provided by Taiseiplas Co., Ltd.). Bonding strength was measured using an MTS Criterion® Series 40 Electromechanical Universal Test Systems (Model 44, C44.304) UTM machine at a speed of 5 mm/s.

Plating index was determined according to the two-step (etching/copper chemical deposition) process described above.

The control thermoplastic composition (lacking an LDS additive) and three example thermoplastic compositions according to aspects of the disclosure (Ex1, Ex2, Ex3) were prepared, NMT bonded to the aluminum metal, and tested as shown in Table 3. MVR was tested per ASTM D1238. Tensile Modulus, Tensile Stress, and Tensile Strain were tested per ASTM D638. Notched Izod was tested per ASTM D256. HDT was tested per ASTM D648.

TABLE 3
PBT compositions with GF1.

| Item | Unit | Control 1 | Ex1 | Ex2 | Ex3 |
|---|---|---|---|---|---|
| PBT | % | 62.4 | 57.4 | 57.4 | 57.4 |
| GF1 | % | 30 | 30 | 30 | 30 |
| EH1 | % | 2.5 | 2.5 | 2.5 | 2.5 |
| IM1 | % | 2 | 2 | 2 | 2 |
| IM2 | % | 3 | 3 | 3 | 3 |
| STAB | % | 0.1 | 0.1 | 0.1 | 0.1 |
| LDS1 | % | | 5 | | |
| LDS2 | % | | | 5 | |
| LDS3 | % | | | | 5 |
| MVR, 250° C., 5 kilogram | Cubic | 22 | 30.2 | 10.7 | 23.5 |
| (kg), 300 seconds (s) | centimeters | | | | |
| | per 10 | | | | |
| | minutes | | | | |
| | (cm³/10 min) | | | | |
| MVR, 250° C., 5 kg, 300 s | cm³/10 min | 24 | 37.2 | 17.6 | 44.7 |
| Tensile Modulus | MPa | 7900 | 8400 | 8900 | 8800 |
| Tensile Stress | MPa | 119 | 91 | 113 | 92 |
| Tensile Strain | % | 2.9 | 2.3 | 2.7 | 2.1 |
| Notched Izod Impact, 23° C. | Joules per | 142 | 81 | 132 | 76 |
| | meter (J/m) | | | | |
| HDT, 1.82 MPa, 3.2 | ° C. | 202 | 196 | 199 | 199 |
| millimeters (mm) | | | | | |
| NMT Bonding Strength | MPa | 26 | 29 | 29 | 30 |
| LDS Plating Index | — | 0 | 0.33 | 0.54 | 0.60 |

From these particular Examples, a number of findings are evident for the given thermoplastic composition and bonded aluminum metal. Each of Ex1, Ex2 and Ex3 demonstrated both NMT bonding strength and LDS activity. Each of Ex1, Ex2 and Ex3 had almost the same NMT bonding strength. Further, compared to the Control, each of the LDS additives (copper chromite black, copper hydroxide phosphate, and tin-antimony cassiterite grey) resulted in the Examples having significantly increased NMT bonding strength. Copper hydroxide phosphate (Ex2) and tin-antimony cassiterite grey (Ex3) provided comparable LDS activity, and provided substantially better LDS activity than copper chromite black (Ex1). Copper hydroxide phosphate (Ex2) more closely maintained mechanical performance (particularly stress and impact) as compared to the Control, while copper chromite black (Ex1) and tin-antimony cassiterite Grey (Ex3) had a negative effect on mechanical performance.

A series of thermoplastic compositions comprising glass fiber and an LDS additive having a smaller particle size were evaluated (GF2 at 600 nm diameter). The results are presented in Table 4.

TABLE 4
PBT compositions and GF2.

| | | Control | | | | | | |
|---|---|---|---|---|---|---|---|---|
| Item | Unit | 2 | Ex4 | Ex5 | Ex6 | Ex7 | Ex8 | Ex9 |
| PBT | % | 62.4 | 57.4 | 57.4 | 57.4 | 57.4 | 52.4 | 52.4 |
| GF2 | % | 30 | 30 | 30 | 30 | 30 | 30 | 30 |
| EH1 | % | 2.5 | 2.5 | 2.5 | 2.5 | 2.5 | 2.5 | 2.5 |
| IM1 | % | 2 | 2 | 2 | 2 | 2 | 2 | 2 |
| IM2 | % | 3 | 3 | 3 | 3 | 3 | 3 | 3 |
| STAB | % | 0.1 | 0.1 | 0.1 | 0.1 | 0.1 | 0.1 | 0.1 |
| LDS1 | % | | 5 | | | | 10 | |
| LDS2 | % | | | 5 | | | | |
| LDS3 | % | | | | 5 | | | 10 |
| LDS4 | % | | | | | 5 | | |
| MVR, 250° C., | cm³/10 | 44.6 | 53.2 | 58.3 | 32.8 | 56.2 | 44.4 | 21 |
| 5 kg, 300 s | min | | | | | | | |
| Tensile | MPa | 9240 | 8930 | 8996 | 9456 | 8916 | 9182 | 9686 |
| Modulus | | | | | | | | |
| Tensile Stress | MPa | 121 | 94.2 | 95.2 | 122.8 | 95.9 | 93.7 | 117.9 |
| Tensile Strain | % | 2.2 | 2.1 | 2.1 | 2.3 | 1.9 | 2.0 | 2.2 |
| Flexural | MPa | 7730 | 7640 | 7750 | 7870 | 7730 | 7760 | 8010 |
| Modulus | | | | | | | | |
| Flexural Stress | MPa | 183 | 149 | 149 | 176 | 151 | 146 | 173 |
| Notched Izod | J.m-1 | 138 | 75.5 | 79.8 | 135 | 76.8 | 79.3 | 140 |
| Impact, 23° C. | | | | | | | | |
| Unnotched Izod | J.m-1 | 860 | 612 | 593 | 880 | 618 | 631 | 884 |
| Impact, 23° C. | | | | | | | | |
| HDT, 1.82 MPa, | ° C. | 212 | 200 | 201 | 208 | 202 | 199 | 205 |
| 3.2 mm | | | | | | | | |
| NMT Bonding | MPa | 26 | 27 | 29 | 27 | 27.5 | 28.3 | 27.3 |
| Strength | | | | | | | | |
| (280° C./140° C.) | | | | | | | | |
| LDS Plating | — | | 0.8 | 0.86 | 0.67 | 0.74 | 0.89 | 0.7 |
| Index | | | | | | | | |

From these particular Examples, a number of findings were evident for the given thermoplastic composition and bonded aluminum metal. Each of Ex4 Ex9 with another GF type: flat GF (GF2) demonstrated both NMT bonding strength and LDS activity. Compared to the Control 2, each of the LDS additives (copper chromite black, copper hydroxide phosphate, and tin-antimony cassiterite grey) increased NMT bonding strength. Copper chromite black having a smaller particle size (Ex5) provided substantially better bonding improvement than copper chromite black having a larger particle size (Ex4). Compounds with higher LDS additive loading had better bonding strength than those with lower bonding, see, e.g., copper chromite black (Ex8 better than Ex4) and copper hydroxide phosphate (Ex9 better than Ex6). Introducing flat GF (GF2) in compounds (Ex4, Ex6 or Ex7) provided a significant improvement in LDS activity than the compounds with round GF (Ex1, Ex2 or Ex3). In particular, for compounds of copper hydroxide phosphate, Flat GF filled compounds (Ex4) had a PI value higher than 0.8, while the PI value of round GF filled compounds (Ex1) was only 0.33. Copper chromite black having a smaller particle size (Ex5) provided better LDS activity than copper Chromite black having a larger particle size (Ex4); Both copper chromite black provide better LDS activity than Copper hydroxide phosphate (Ex6) and tin-antimony cassiterite grey (Ex7). Copper hydroxide phosphate (Ex6) more closely maintained mechanical performance (particularly stress and impact) as compared to the Control, while copper chromite black (E×4 and E×5) and tin-antimony cassiterite Grey (Ex7) had a negative effect on mechanical performance.

Samples including different thermoplastic resins were also prepared and evaluated. Table 5 presents the values for polycarbonate-based resins (HFD and EXL).

TABLE 5
Polycarbonate-based resins.

| Item | Unit | Control 3 | Ex10 | Ex11 |
|---|---|---|---|---|
| HFD PC, low Mw | % | 27.05 | 22.55 | 22.55 |
| HFD PC, high Mw | % | 17.05 | 17.45 | 13.55 |
| EXL PC | % | 10 | 10 | 10 |
| EXL PC, transparent | % | 15 | 15 | 15 |
| STAB 1 | % | 0.1 | 0.1 | 0.1 |
| STAB 2 | % | 0.1 | 0.1 | 0.1 |
| STAB 3 | % | 0.1 | 0.1 | 0.1 |
| STAB 4 | % | 0.1 | 0.1 | 0.1 |
| IM 4 | % | 0.5 | 0.5 | 0.5 |
| MR | % | 0.5 | 0.5 | 0.5 |
| STAB 5 | % | 0.1 | 0.1 | 0.1 |
| GF2 | % | 30 | 30 | 30 |
| LDS1 | % | | 4 | |
| LDS4 | % | | | 8 |
| MVR, 280° C., 2.16 kg, 300 s | cm³/ | 8.7 | 8.6 | 8.89 |
| | 10 min | | | |
| MVR, 300° C., 2.16 kg, 300 s | cm³/ | 16.9 | 17.2 | 18.4 |
| | 10 min | | | |
| Tensile Modulus | MPa | 8360 | 7895 | 8430 |
| Tensile Stress | MPa | 110 | 90.3 | 91.3 |
| Tensile Strain | % | 2.4 | 2 | 1.9 |
| Flexural Modulus | MPa | 7120 | 6500 | 7210 |
| Flexural Stress | MPa | 161 | 130 | 134 |
| Notched Izod Impact, 23° C. | J · m−1 | 151 | 100 | 89.2 |
| Unnotched Izod Impact, | J · m−1 | 505 | 403 | 373 |
| 23° C. | | | | |
| HDT, 1.82 MPa, 3.2 mm | ° C. | 126 | 121 | 121 |
| NMT Bonding Strength | MPa | 18 | 20 | 28.5 |
| (270° C./130° C.) | | | | |
| LDS Plating Index | — | | 1 | 1 |

From these particular Examples, a number of findings were evident for the given thermoplastic composition and bonded aluminum metal. Each of Ex10, Ex11 demonstrated both NMT bonding strength and LDS activity. Compared to Control 3, each of the LDS additives (copper chromite black, and tin-antimony cassiterite grey) resulted in the Examples having significantly increased NMT bonding strength, especially for tin-antimony cassiterite grey (Ex11). Copper chromite black (Ex10) and tin-antimony cassiterite grey (Ex11) provided comparable outstanding LDS activity. Compared with Control 3, both copper chromite black (Ex10) and tin-antimony cassiterite Grey (Ex11) had a negative effect on mechanical performance.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

1. A thermoplastic composition comprising:
a polymeric base resin;
a glass fiber component; and
a laser direct structuring additive, the laser direct structuring additive comprising copper chromite black, copper hydroxide phosphate, tin-antimony cassiterite grey or a combination thereof.

2. The thermoplastic composition according to claim 1, wherein the polymeric base resin comprises polybutylene terephthalate (PBT), polyamide (PA), polycarbonate (PC), poly(p-phenylene oxide) (PPO), or combinations thereof.

3. The thermoplastic composition according to claim 1, wherein the polymeric base resin is present in an amount of from about 20 wt. % to about 90 wt. %.

4. The thermoplastic composition according to claim 1, wherein the glass fiber component comprises round glass fiber having a diameter of from about 7 μm to about 15 μm, or a flat glass fiber, or a combination thereof.

5. The thermoplastic composition according to claim 1, wherein the glass fiber component is present in an amount of from about 10 wt. % to about 60 wt. %.

6. The thermoplastic composition according to claim 1, wherein the glass fiber component is present in an amount of from about 20 wt. % to about 40 wt. %.

7. The thermoplastic composition according to claim 1, wherein the laser direct structuring additive is present in an amount of from about 0.5 wt. % to about 20 wt. %.

8. The thermoplastic composition according to claim 1, wherein the laser direct structuring additive is present in an amount of from about 2 wt. % to about 12 wt. %.

9. The thermoplastic composition according to claim 1, further comprising an enhancer in an amount of up to about 10 wt. %.

10. The thermoplastic composition according to claim 1, further comprising an impact modifier in an amount of up to about 10 wt. %.

11. The thermoplastic composition according to claim 1, wherein the thermoplastic composition comprises a nano molding technology bonding strength of at least about 20 MPa when bonded to aluminum alloy.

12. The thermoplastic composition according to claim 1, wherein the thermoplastic composition comprises a plating index of at least about 0.25.

13. A method for making a thermoplastic article, comprising:
forming a blend by mixing:
a polymeric base resin;
a glass fiber component; and
a laser direct structuring additive, the laser direct structuring additive comprising copper chromite black, copper hydroxide phosphate, tin-antimony cassiterite grey or a combination thereof, and
injection molding, extruding, rotational molding, blow molding or thermoforming the blend to form the thermoplastic article.

14. The method according to claim 13, wherein the polymeric base resin comprises polybutylene terephthalate, polyamide, polycarbonate, poly(p-phenylene oxide), or combinations thereof.

15. The method according to claim 13, wherein the thermoplastic article comprises a nano molding technology bonded cover of a consumer electronics device.

16. The method according to claim 13, wherein the polymeric base resin is present in an amount of from about 20 wt. % to about 90 wt. %, the glass fiber component is present in an amount of from about 10 wt. % to about 60 wt. %, and the laser direct structuring additive is present in an amount of from about 0.5 wt. % to about 20 wt. %.

17. The method according to claim 13, wherein the blend further comprises an enhancer in an amount of up to 10 wt. %.

18. The method according to claim 13, wherein the blend further comprises an impact modifier in an amount of up to 10 wt. %.

19. The method according to claim 13, wherein the thermoplastic article comprises a nano molding technology bonding strength of at least 20 MPa when bonded to aluminum alloy.

20. The method according to claim 13, wherein the thermoplastic article comprises a plating index of at least 0.25.
